(19) United States
(12) Patent Application Publication
(10) Pub. No.: US 2013/0091065 A1
(43) Pub. Date: Apr. 11, 2013

(54) AUTOMATIC SPIKE LICENSING

(71) Applicants: David Telehowski, Pacific Palisades, CA (US); Jim Ling, Mountain View, CA (US); Liju George, Fremont, CA (US); Matthew Dieckman, San Jose, CA (US); Arvind Gopalan, Santa Clara, CA (US); Bhimaraju Prasad, Cupertino, CA (US); Shunhui Zhu, San Jose, CA (US)

(72) Inventors: David Telehowski, Pacific Palisades, CA (US); Jim Ling, Mountain View, CA (US); Liju George, Fremont, CA (US); Matthew Dieckman, San Jose, CA (US); Arvind Gopalan, Santa Clara, CA (US); Bhimaraju Prasad, Cupertino, CA (US); Shunhui Zhu, San Jose, CA (US)

(73) Assignee: SONICWALL, INC.

(21) Appl. No.: 13/270,184

(22) Filed: Oct. 10, 2011

(51) Int. Cl. G06Q 50/10

(52) U.S. Cl. 705/310

(57) ABSTRACT

A license for one or more services may include a certain service capacity under the license. The services may be provided under the license within the service capacity. When there is a spike in service requests, the services requested may exceeds the service capacity under the license. It may be determined that the license includes a spike provision that allows for requested services to be provided in excess of the service capacity under the license. The spike provision may be activated so that the requested services in excess of the service capacity under the license are provided under the spike provision

### BACKGROUND OF THE INVENTION

1. Field of the Invention

The present invention generally relates to licensing. More specifically, the present invention relates to automatic spike licensing.

2. Description of the Related Art

There are presently a variety of services that are provided to end-users over a communication network. Many services are provided under a license or set of licenses. A company, for example, may license a service for use by its employees. Such a license may include various terms regarding the services, users, and conditions of use. A licensed service that charges per user connection, for example, may have limits on the number of users that can be connected at any given time under the license. As such, any additional requests for the service may be refused once the limit is reached.

To increase that number, the licensee is traditionally required to purchase additional permanent licenses, which may be extremely expensive and cost-prohibitive for many small businesses. Alternatively, some services allow for purchase of temporary licenses. Such licenses may require purchase and/or activation by an IT administrator. Inefficiencies and/or delay may arise when the IT administrator is not immediately available to purchase and activate the requisite licenses when demand begins to rise. There may be delay in detecting the increased in demand and deploying a solution responsive to the demand.

Such delay may be detrimental to a company's productivity, particularly in times where need for the service may spike suddenly. Such spikes may be seasonal, or may be the result of emergency or disaster. In certain emergencies (e.g., natural disaster, war-time, terrorist attack, transportation strikes, pandemic/outbreaks), certain users may be physically constrained to a remote location, and as such, may need to be able to obtain services over a communication network.

For some companies, a natural disaster may lead to hundreds, if not thousands, of users needing to access certain services remotely. Where such a spike in demand occurs, however, an IT administrator may not be able to immediately detect and respond to the same by purchasing and enabling the required licenses. Similarly, when the spike in need subsides, the IT administrator may not be immediately aware that the temporary license need no longer be deployed. Such imprecise determinations allow for temporary licenses to continue in force longer than necessary, which may result in accrual of unnecessary fees.

There is a need for improved systems and methods for providing automatic spike licenses.

### SUMMARY OF THE CLAIMED INVENTION

Embodiments of the present invention include systems and methods for providing automatic spike licenses. A license for one or more services may include a certain service capacity, which allows for the services to be provided under the license within the service capacity. When there is a spike in service requests, however, the services requested may exceed the service capacity under the license. In response, it may be determined that the license includes a spike provision that allows for requested services to be provided in excess of the service capacity. The spike provision may be activated so that the requested services in excess of the service capacity are provided under the spike provision.

Various embodiments of the present invention include methods for providing automatic spike licenses. Such methods may include storing information in memory regarding a license for one or more services and indicating a service capacity under the license, receiving one or more incoming requests sent over a communication network regarding the one or more services, detecting a spike in demand such that a total of services currently being provided and services currently being requested exceeds the service capacity under the license, determining that the stored information regarding the license includes a spike provision, and activating the spike provision in order to provide the requested services in excess of the service capacity under the license according to the spike provision.

Embodiments of the present invention may further include systems for providing automatic spike licenses. Such systems may include a database in memory for storing information regarding a license for one or more services and indicating a service capacity under the license, a network interface for receiving one or more incoming requests sent over a communication network regarding the one or more services, and a processor for executing instructions stored in memory in order to detect a spike in demand such that a total of services currently being provided and services currently being requested exceeds the service capacity under the license, to determine that the stored information regarding the license includes a spike provision, and to activate the spike provision in order to provide the requested services in excess of the service capacity under the license according to the spike provision.

Other embodiments of the present invention include non-transitory computer-readable storage media on which is embodied instructions executable to provide automatic spike licenses in general accordance with the method previously set forth above.

### BRIEF DESCRIPTION OF THE DRAWINGS

FIG. 1 illustrates a network environment in which automatic spike licenses may be implemented.

FIG. 2 illustrates a method for providing automatic spike licenses.

### DETAILED DESCRIPTION

Embodiments of the present invention allow for providing automatic spike licenses. A license for one or more services may include a certain service capacity, which allows for the services to be provided under the license within the service capacity. When there is a spike in service requests, however, the services requested may exceed the service capacity under the license. In response, it may be determined that the license includes a spike provision that allows for requested services to be provided in excess of the licensed service capacity. The spike provision may be activated so that the requested services in excess of the licensed service capacity are provided under the spike provision.

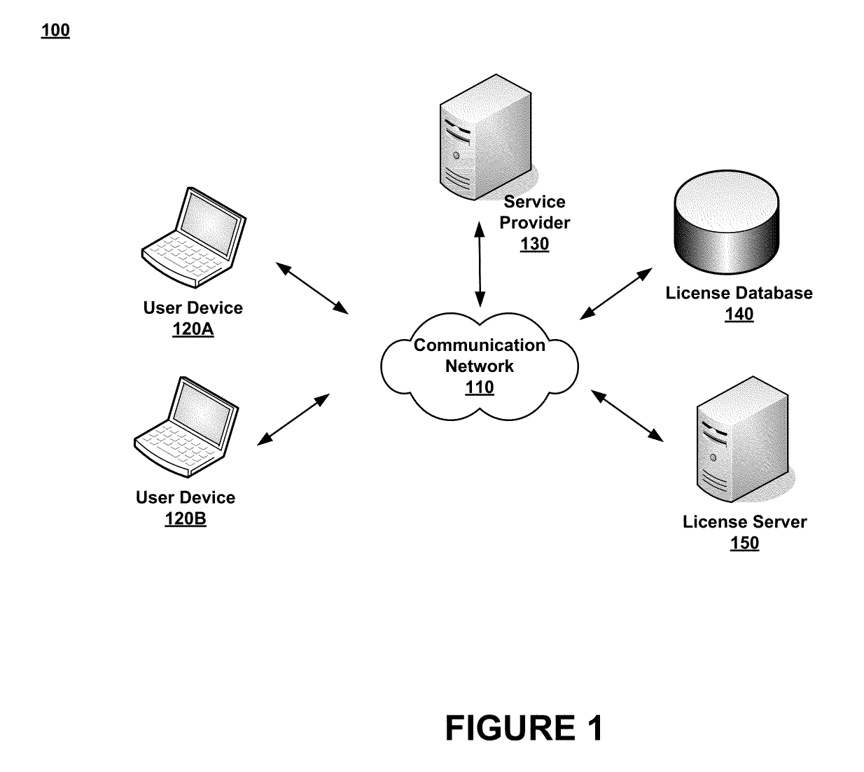

FIG. 1 illustrates a network environment 100 in which automatic spike licenses may be implemented. Network environment 100 may include a communication network 110, one or more user devices 120A-B, at least one service provider 130, a license database 140, and a license server 150. Devices in network environment 100 may communicate with each other via communications network 110.

Communication network 110 may be a local, proprietary network (e.g., an intranet) and/or may be a part of a larger wide-area network. The communications network 110 may be a local area network (LAN), which may be communicatively coupled to a wide area network (WAN) such as the Internet. The Internet is a broad network of interconnected computers and servers allowing for the transmission and exchange of Internet Protocol (IP) data between users connected through a network service provider. Examples of network service providers are the public switched telephone network, a cable service provider, a provider of digital subscriber line (DSL) services, or a satellite service provider. Communications network 110 allows for communication between the various components of network environment 100.

Users may use any number of different electronic user devices 120A-B, such as general purpose computers, mobile phones, smartphones, personal digital assistants (PDAs), portable computing devices (e.g., laptop, netbook, tablets), desktop computing devices, handheld computing device, or any other type of computing device capable of communicating over communication network 110. User devices 120 may also be configured to access data from other storage media, such as memory cards or disk drives as may be appropriate in the case of downloaded services. User device 120 may include standard hardware computing components such as network and media interfaces, non-transitory computer-readable storage (memory), and processors for executing instructions that may be stored in memory.

While the network environment illustrated in FIG. 1 uses communication network 110 to convey information between separate devices, alternative implementations may allow for direct communication between devices that may or may not be housed separately. In such implementations, user devices 120A-B may further encompass such communication interfaces as known in the art for conveying user information, including buttons, keypads, microphones, and voice recognition.

Service provider 130 can encompass any type of service that can be licensed and/or delivered over a communication network 110. Examples include any aspect of cloud computing, software-as-a-service, enterprise resource management, content management, and bandwidth management. While service provider 130 is illustrated as a single entity, service provider 130 may encompass any number of service providers and intermediary or accessory devices. Service provider 130 can receive, process, and respond to communications sent by user devices 120.

Service provider 130 may include any type of server or other computing device as is known in the art, including standard hardware computing components such as network and media interfaces, non-transitory computer-readable storage (memory), and processors for executing instructions or accessing information that may be stored in memory. The functionalities of multiple servers may be integrated into a single server. Any of the aforementioned servers (or an integrated server) may take on certain client-side, cache, or proxy server characteristics. These characteristics may depend on the particular network placement of the server or certain configurations of the server.

To facilitate the evaluation of a request for service, service provider 130 of FIG. 1 may consult with a license database 140. The license database 140 may be local or remote to the service provider 130. Further, the information in the license database 140 may also be aggregated in one location as illustrated in FIG. 1, or stored separately in multiple databases. Service provider 130 can access the stored data in the license database 140, as well as information derived from or related to the same, in order to facilitate services provided to user devices 120. The service provider 130 may also receive information (e.g., updates) from user devices 120 and store the same in the license database 140.

Upon receiving a request for service, service provider 130 may evaluate the request to determine who the requesting user is, what service is being requested, whether the service is covered by the license, and whether to provide the service. For example, a request may be received from user device 120A. The request is evaluated to determine who is the requesting user associated with user device 120A and what service is being requested. The identity of the requesting user may be used to look up any applicable licenses in license database 140. Further, the license(s) associated with the requesting user is evaluated to determine whether the requested service is covered by the license and applicable requirements are satisfied. Once the request is approved, service provider 130 may then provide user device 120A with the requested service.

Some licensed services, such as those licensed to a company, may indicate such terms as the number of users that are licensed to use the service at a time. The service capacity under the license may not equal the capacity that can be provided, however. For example, a service provider 130 may be capable of providing service to 100 users, but a company may only need services provided to 10 users. Under certain circumstances, however, demand for the service may increase temporarily, but dramatically. During the initial days after natural disaster, for example, individuals may need or wish to work from home, accessing services remotely over communications network 110. To accommodate such spikes in demand, some service providers 130 may include a spike provision with the license. A spike provision allows for additional users in excess of the licensed capacity to access services from the service provider 130.

As along as the number of users currently being provided with a service and the number of incoming requests for the service are less than the licensed capacity, the service is provided under the (non-spike) terms of the license. Once the total exceeds the licensed capacity, service provider 130 may consult license database 140 to determine whether the license is associated with any spike provision. If not, then the number of users in excess of the licensed capacity may be refused service. If there is a spike provision, however, that spike provision may be automatically invoked to accommodate for the excess users. When users begin to log-off or otherwise terminate the service, service provider 130 may re-evaluate the total number of users being provided and/or requesting the service. If the total number falls to or beneath the licensed capacity, the service provider 130 may automatically deactivate the spike provision. The automatic activation and deactivation of the spike license allows for a service provider 130 to immediately respond to changes in demand.

License server 150 may be associated with one or more service providers 130, a systems administrator, a license administrator, or any party that wishes to make services available to users in network environment 100. License server 150, which may or may not be associated with license database 140, may be similar to service provider 130 with respect to such standard hardware computing components such as network and media interfaces, non-transitory computer-readable storage (memory), and processors for executing instructions that may be stored in memory. License server 150 allows an entity to communicate regarding any services the entity wishes to license and to specify the associated terms and conditions. For example, a user may use license server 150 to purchase a new license for services, or to update a pre-existing license with new terms and conditions. If a user is denied service by service provider 130, for example, the user may be provided with an option for purchasing (or updating) a license or spike provision under which the requested services may be obtained. The spike provision may be packaged in predetermined periods of time (e.g., 10 days, 1 month, 6 months) and/or predetermined bundles of service (e.g., up to 10 users, 20 users, 500 users).

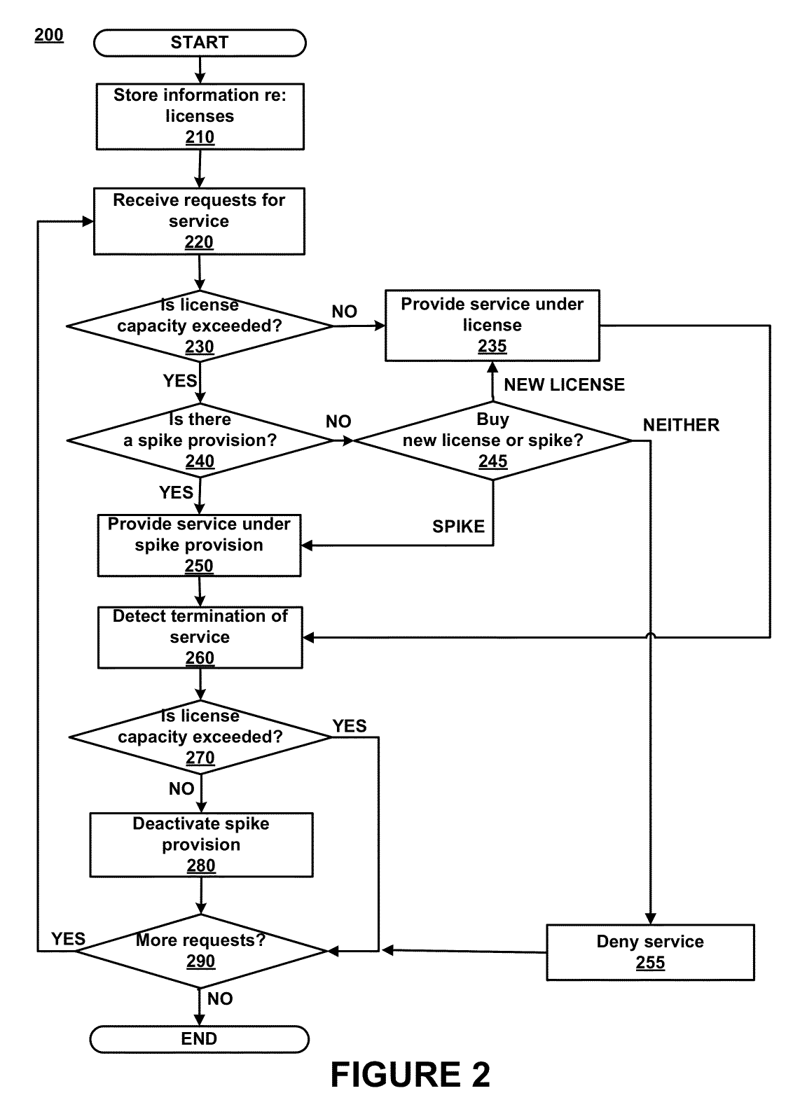

FIG. 2 illustrates a method 200 for providing automatic spike licensing. The method 200 of FIG. 2 may be embodied as executable instructions in a non-transitory computer readable storage medium including but not limited to a CD, DVD, or non-volatile memory such as a hard drive. The instructions of the storage medium may be executed by a processor (or processors) to cause various hardware components of a computing device hosting or otherwise accessing the storage medium to effectuate the method. The steps identified in FIG. 2 (and the order thereof) are exemplary and may include various alternatives, equivalents, or derivations thereof including but not limited to the order of execution of the same.

In method 200 of FIG. 2, information may be stored regarding a license, a request for service may be received, and it may be determined whether licensed capacity is exceeded. Where licensed capacity is not exceeded, services are provided under license. Where the licensed capacity is found to be exceeded, it may be determined whether the license includes a spike provision. If there is no spike provision, an offer to sell a spike provision may be made. If there is a spike provision or a spike provision is bought, services may be provided under the spike provision. Once the spike provision is activated, one or more users may choose to terminate their use of the service. It is then re-evaluated whether the license capacity continues to be exceeded. If the licensed capacity is no longer exceeded, the spike provision is deactivated.

In step 210, information regarding one or more licenses is maintained in license database 140. License database 140 may encompass one or multiple databases for storing information regarding services, service providers, licensees, users, and various provisions, including spike provisions for responding to spikes in demand. Such information may be provided by the service providers, licensees, users, designated information sources, and systems administrators. License databases 140 may serve as a repository for information used to manage and implement licensed services to users under defined parameters.

In step 220, a request is received at a service provider 130 or other computing device tasked with determining whether and how to provide the requested service. The request may be submitted by any method known in the part, including via email, instant message, SMS text message, or clicking on a button or hyperlink. The request may concern access to services associated with a licensee (e.g., company) and include additional information (e.g., an identifier associated with the requesting user or user device 120) that may be used to process the request. By searching license database 140, service provider 130 may be able to identify the requesting user, the associated licensee (e.g., company employing the requesting user), as well as the parameters governing access (and/or use) of the service.

In step 230, it is determined whether the licensed capacity is exceeded. Depending on the terms of the license, the licensed capacity may refer to a number of users, an amount of bandwidth, or some other parameter pertaining to the service or services provided by service provider 130. For example, where licensed capacity refers to a number of users, the license identified in the request received in step 220 may be evaluated to determine whether the current level of users being provided with the service and users sending incoming requests exceed the licensed capacity. If the license capacity is exceeded, the method may proceed to step 240. If the license capacity is not exceeded, the method may proceed to step 235, in which the requested service is provided according to the license. Where services are provided under the license within the licensed capacity, the method may skip ahead to step 260, which described in further detail below.

In step 240, it is determined whether there is spike provision in the license identified in the received request. The licensed capacity is generally less than the maximum capacity that can be handled. A spike provision, which may be packaged with the license or purchased separately from the license, concerns providing services to users in excess of the licensed capacity on a temporary basis (e.g., the duration of a spike in demand). The increased capacity may be expressed as an increased percentage, an increased number of users, an increased amount of bandwidth, or increase in another parameter known in the art to be associated with licensed services provided over a communication network 110. The increased capacity may be limited by the maximum capacity.

The determination as to whether there is a spike provision may be made by reference to license database 140, which may also store information regarding the availability and terms of the spike provision (e.g., increase capacity from 10 users to 100 users for 10 days out of the 30 days originally purchased). Where it is determined that no spike provision is currently associated with the license, the method may proceed to step 245. If a spike provision is already in place, the method may proceed to step 250.

In step 245, an offer to sell an additional (permanent) license or a spike provision may be made. While some licensees may have already purchased a spike provision at the same time the license agreement was made, some licensees may be offered the opportunity to add a spike provision at a later point in time (or extend a pre-existing spike provision). Where there is a spike in demand beyond a licensed capacity, for example, the licensee (or a designated administrator) may be notified over communication network 110 regarding the same and provided with one or more options to purchase additional permanent license(s) or a spike provision/extension. The purchase and associated updates to the license and/or spike provision may be handled by license server 150 in conjunction with license database 140. The update may also be automatically processed in real-time so as to allow additional users to be serviced under either the additional license (e.g., step 235) or spike provision (e.g., step 250). If the licensee declines the offer to buy additional license(s) or spike provision, no additional users may be accommodated beyond the licensed capacity. As such, a requesting user may be denied service in step 255 (e.g., error message) and may have to wait until one of the users currently being provided with the service logs off or otherwise terminates the service.

In step 250, the requested service(s) are provided by the service provider 130 under the spike provision. As such, services may be provided at a capacity exceeding that under the license. For example, where the licensed capacity may allow for 10 users, the spike provision may allow for up to 100 users. The overall capacity that may be handled under the spike license may be restricted by the limitations of the communication network 110 and/or the service provider 130. When the spike provision is activated and services are provided under the spike provision, the availability of the spike provision may be adjusted. For example, where there are 10 days available, activation of the spike license may result in deducting a day. At the end of the day, another day may be deducted if the spike provision has not been deactivated.

In step 260, termination of a service may be detected. A user currently receiving a service may log-off the service, shut down user device 120, or otherwise indicate a wish to terminate the service. Alternatively, it may be the service provider 130 that terminates the service. For example, a service may time out after a period of inactivity, or the user device 120 may not comply with security policies or other requirements of the service provider 130. Termination of services may be accomplished by service provider 130 sending a signal or other information to user device 120 that causes certain service to be disabled or otherwise blocked.

In step 270, it is determined whether the licensed capacity continues to be exceeded by the current number of serviced and requesting users in light of the termination of services detected in step 260. Where the licensed capacity is still exceeded, the spike provision may remain active and services may continue to be provided under the spike provision. If the term of the spike provision elapses, it may be automatically renewed. Renewal may include deducting another day (or other unit of time or service) from the available term. In some instances, renewal may involve purchasing a new spike provision or an extension to the spike provision. Further, where the licensed capacity is still exceeded, the method may skip to step 290 for detection of additional requests, which are received and handled as described in step 220.

Where the licensed capacity is no longer exceeded, the method proceeds to step 280. In step 280, the spike provision is deactivated. When the term of the spike provision ends, it is not renewed. As such, service that are provided thereafter are provided under the license (and within the licensed capacity), not the spike provision.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASHEPROM, and any other memory chip or cartridge.

Various forms of transmission media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU. Various forms of storage may likewise be implemented as well as the necessary network interfaces and network topologies to implement the same.

While various embodiments have been described above, it should be understood that they have been presented by way of example only, and not limitation. The descriptions are not intended to limit the scope of the invention to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the invention as defined by the appended claims and otherwise appreciated by one of ordinary skill in the art. The scope of the invention should, therefore, be determined not with reference to the above description, but instead should be determined with reference to the appended claims along with their full scope of equivalents.

What is claimed is:

1. A method for providing automatic spike licensing, the method comprising:
storing information in memory regarding a license for one or more services, wherein the stored information indicates a service capacity under the license;
receiving one or more incoming requests regarding the one or more services; and
executing instructions stored in memory, wherein execution of the instructions by a processor:
detects a spike in demand for the services, wherein a total of services currently being provided and services currently being requested exceeds the service capacity under the license,
determines that the stored information regarding the license includes a spike provision, and
activates the spike provision, wherein requested services in excess of the service capacity under the license are provided according to the spike provision.

2. The method of claim 1, further comprising evaluating one of the incoming requests prior to detection of the spike, the evaluation of the request comprising:
identifying one or more services indicated by the request;
determining that the identified services can be provided without exceeding the service capacity under the license; and
providing the identified services in response to the request, the identified services being provided according to the license.

3. The method of claim 1, wherein the services provided according to the spike provision are limited by a predetermined maximum capacity.

4. The method of claim 1, further comprising:
detecting an action terminating one or more services;
determining that the total of the services currently being provided and the services currently being requested no longer exceeds the service capacity under the license; and
deactivating the spike provision.

5. The method of claim 1, wherein the spike provision is associated with a term lasting a predetermined period of time and further comprising renewing the spike provision at the end of the term based on the total of services currently being provided and services currently being requested continuing to exceed the service capacity under the license, wherein services are provided to the excess requesting users according to the spike provision for another term.

6. The method of claim 5, wherein the spike provision comprises a plurality of terms and wherein a term is deducted from the plurality of terms associated with the spike provision when the spike provision is activated or renewed.

7. The method of claim 6, further comprising adding an additional term to the plurality of terms upon payment of a predetermined fee by a licensee.

8. The method of claim 1, wherein determining that the stored information regarding the license includes a spike provision comprises:
initially determining that the license does not include the spike provision;
receiving a request over the communication network from a licensee regarding purchase of the spike provision;
confirming payment associated with the purchase of the spike provision, and
updating the stored information regarding the license to reflect inclusion of the spike provision.

9. A system for providing automatic spike licensing, the system comprising:
a database in memory for storing information regarding a license for one or more services, wherein the stored information indicates a service capacity under the license;
an interface for receiving one or more incoming requests regarding the one or more services; and
a processor for executing instructions stored in memory, wherein execution of the instructions by the processor:
detects a spike in demand for the services, wherein a total of services currently being provided and services currently being requested exceeds the service capacity under the license,
determines that the stored information regarding the license includes a spike provision, and
activates the spike provision, wherein requested services in excess of the service capacity under the license are provided according to the spike provision.

10. The system of claim 9, wherein further execution of instruction by the processor evaluates one of the incoming requests prior to detection of the spike, the evaluation of the request comprising:
identifying one or more services indicated by the request;
determining that the identified services can be provided without exceeding the service capacity under the license; and
providing the identified services in response to the request, the identified services being provided according to the license.

11. The system of claim 9, wherein the services provided according to the spike provision are limited by a predetermined maximum capacity.

12. The system of claim 9, wherein further execution of instruction by the processor:
detects an action terminating one or more services;
determines that the total of the services currently being provided and the services currently being requested no longer exceeds the service capacity under the license; and
deactivates the spike provision.

13. The system of claim 9, wherein the spike provision is associated with a term lasting a predetermined period of time and wherein further execution of instruction by the processor renews the spike provision at the end of the term based on the total of services currently being provided and services currently being requested continuing to exceed the service capacity under the license, wherein services are provided to the excess requesting users according to the spike provision for another term.

14. The system of claim 13, wherein the spike provision comprises a plurality of terms and wherein a term is deducted from the plurality of terms associated with the spike provision when the spike provision is activated or renewed.

15. The system of claim 14, wherein further execution of instruction by the processor adds an additional term to the plurality of terms upon payment of a predetermined fee by a licensee.

16. The system of claim 9, wherein determining that the stored information regarding the license includes a spike provision comprises initially determining that the license does not include the spike provision and sending a request over the communication network regarding purchase of the spike provision from a licensing server.

17. The system of claim 16, further comprising the licensing server for:
receiving the request regarding the purchase of the spike provision;
confirming payment associated with the purchase of the spike provision; and
sending an update to the stored information regarding the license to reflect inclusion of the spike provision, the update sent over the communication network to the database.

18. A non-transitory computer-readable storage medium, having embodied thereon a program executable by a processor to perform a method for providing automatic spike licensing, the method comprising:
storing information regarding a license for one or more services, wherein the stored information indicates a service capacity under the license;
receiving one or more incoming requests regarding the one or more services;
detecting a spike in demand for the services, wherein a total of services currently being provided and services currently being requested exceeds the service capacity under the license;
determining that the stored information regarding the license includes a spike provision; and
activating the spike provision, wherein requested services in excess of the service capacity under the license are provided according to the spike provision.

19. The non-transitory computer-readable storage medium of claim 18, further comprising instructions executable by the processor to evaluate one of the incoming requests prior to detection of the spike, the evaluation of the request comprising:
identifying one or more services indicated by the request;
determining that the identified services can be provided without exceeding the service capacity under the license; and
providing the identified services in response to the request, the identified services being provided according to the license.

20. The non-transitory computer-readable storage medium of claim 18, further comprising instructions executable by the processor to:
detect an action terminating one or more services;
determine that the total of the services currently being provided and the services currently being requested no longer exceeds the service capacity under the license; and
deactivate the spike provision.
